(19) United States
(12) Patent Application Publication
(10) Pub. No.: US 2021/0261309 A1
(43) Pub. Date: Aug. 26, 2021

(54) DYNAMIC MODIFIED ATMOSPHERE PACKAGING MATERIAL FOR FRESH HORTICULTURAL PRODUCTS

(71) Applicant: Stichting Wageningen Research, Wageningen (NL)

(72) Inventors: Geraldus Gerardus Johannes Schennink, Wehl (NL); Maxence Jacky Michel Paillart, Wageningen (NL); Eelke Hemmes Westra, Rhenen (NL)

(21) Appl. No.: 17/253,684

(22) PCT Filed: Jun. 28, 2019
(86) PCT No.: PCT/EP2019/067393

§ 371 Date: Dec. 18, 2020

(30) Foreign Application Priority Data
Jun. 29, 2018 (EP) 18180904.7

(51) Int. Cl. B65D 65/40; C08J 5/18; B65D 85/34; B65D 85/50; B65D 81/18; B32B 27/32; B32B 27/08; A23B 7/148

(52) U.S. Cl. CPC B65D 65/40; A23V 2002/00; B65D 85/34; B65D 85/505; B65D 81/18; B32B 27/32; B32B 27/08; A23B 7/148; C08J 2403/02; C08J 2323/06; B32B 2250/03; B32B 2250/242; B32B 2250/40; B32B 2307/728; B32B 2307/73; B32B 2439/70; C08J 5/18

(57) ABSTRACT

The present invention relates to the use of a sheet for extending shelf-life of biological products, wherein the sheet comprises or consists of a thermoplastic composition with a hydrophobic polymer phase comprising at least one hydrophobic polymer; a hydrophilic polymer phase comprising at least one hydrophilic polymer; and optionally at least one compatibiliser.

### TECHNICAL FIELD

The present invention relates to a specific packaging material for fresh horticultural products, in particular a dynamic packaging material that can extend postharvest shelf-life of fresh horticultural products.

### BACKGROUND OF THE INVENTION

Fresh horticultural products such as fruit, vegetables, (flower)bulbs and ornamentals remain biologically active after harvest. The level of this biological activity can dramatically affect the shelf-life of these products. For example, causes of deterioration may reside in respiration rate, ethylene production and sensitivity, rates of compositional changes (associated with quality), water stress, sprouting and rooting, and physiological disorders.

Apart from the specific metabolism of the fresh product, the postharvest level of biological activity strongly depends on the distribution chain conditions. Main parameters are temperature, relative humidity and packaging headspace air composition. Hence, the type of packaging for these products can have an important influence on the quality of the product over time. In particular, the permeability characteristics (i.e. for water vapour, oxygen and carbon dioxide) of packaging materials together with factors like temperature and relative humidity can be decisive.

The amount of oxygen in the packaging should be balanced so that the product can still respire but in limited extent to avoid loss of quality. The same applies to the amount of carbon dioxide. A low level of carbon dioxide inside the packaging may extend the shelf-life of the product, but a high concentration of carbon dioxide may lead to product damage.

An optimal atmosphere is achieved when the gas permeability of the packaging compensates the activity of the product, wherein the activity is preferably kept at a stable level. New sensor technologies and a broad range of packaging materials have made it possible to find the optimal atmosphere for each fresh horticultural product at specific storage conditions.

However, this optimization is still challenging, if not impossible, to obtain when storage conditions vary within the distribution chain. For example, product activity and packaging permeability typically do not increase or decrease in a similar rate when storage conditions change.

It is an objective of the present disclosure to overcome one or more of the above-mentioned problems.

### SUMMARY OF THE INVENTION

The present disclosure provides for the use of a specific packaging material for extending shelf-life of biological products, in particular (fresh) horticultural products, wherein the packaging material comprises or consists of a thermoplastic composition with:
a hydrophobic polymer phase comprising at least one hydrophobic polymer;
a hydrophilic polymer phase comprising at least one hydrophilic polymer; and
optionally at least one compatibiliser.

The present inventors found that the above-mentioned packaging material can adapt its oxygen and carbon dioxide permeability in close accordance to the biological activity of the packaged product. It was found that the packaging material is able to increase its permeability properties in reaction to an increase in storage temperature and/or relative humidity in the direct surrounding of the packaged product. In view thereof, the packaging material finds particular use in storing fresh horticultural products during a period having considerable temperature variation (e.g. of at least 4° C.), for example including a period of cold storage (e.g. between 1-10° C.) and a period of ambient temperature storage (e.g. between 15-30° C.).

The presence of a hydrophilic polymer phase in the packaging material can allow for the increase in gas permeability characteristics upon an increase in temperature and/or relative humidity, thereby adapting to e.g. the respiration rate of the packaged biological product and/or the changing surrounding temperature/humidity. The packaging material preferably has a layered morphology with for example a single (internal) layer, or termed functional layer, comprising or consisting of the thermoplastic composition and/or one or two outer layer(s) comprising or consisting of the thermoplastic composition, or preferably comprising or consisting of hydrophobic polymer phase.

The advantages of the present packaging material include the following:
1) Extending shelf-life: a large number of fruits, vegetables and ornamentals is sensitive to high CO₂ content, which may lead to product discolouration, or to off-odours, or to off-taste and strongly limits the shelf life. Extension of shelf life is in many ways beneficial, leading to commercial benefits and less food waste. In current modified atmosphere packaging with micro perforations, the desired decrease in oxygen results in an unwanted increase in CO₂. The high permeability to CO₂ of the present packaging material can avoid excessive amounts CO₂. On the other hand, the optimal CO₂ and O₂ amount can contribute to maintain high quality of the packaged product.
2) Flexibility in agro-logistics up to the supermarket: distribution chains conditions (duration, temperature and humidity) are dynamic, particularly regarding transport versus ambient conditions. The present packaging material can advantageously be applied in distribution chains with varying or uncontrolled temperatures including the supermarket. The application of modified atmosphere packaging is at the moment limited to production and distribution chains that are at controlled constant temperature. Typically, the transportation is performed at low temperature (e.g. between 1-10° C.) whereas in the last part of the chain (supermarket and consumer) the product may be kept at ambient temperature (e.g. between 15-30° C.). At ambient temperature, the product becomes more biologically active, and too much CO₂ is produced and accumulated in the packaging headspace, which may result in reduced product quality when packed in the packaging materials of the prior art. The present packaging material offers a solution for these issues and increases the flexibility in the supply chain.
3) The composition of the packaging material can be tailored to reach the desired permeability for a particular range of fresh horticultural products. Different fresh products may require different permeabilities in order to cope for example with different metabolism rates, or to meet the requirements of different conditions throughout the distribution chain.

### DETAILED DESCRIPTION OF THE INVENTION

The present disclosure relates to the use of a specific (packaging) sheet for extending shelf-life of at least one biological product, i.e. in a method, wherein the sheet comprises or consists of a (thermoplastic) composition with:
a hydrophobic (bio)polymer phase which may have a water absorption capacity of at most 5 ml water per 100 g of the hydrophobic (bio)polymer phase, preferably comprising at least one polymer, preferably polyolefin, and/or comprising at least one biopolymer; and/or
a hydrophilic (bio)polymer phase which may have a water absorption capacity of at least 5 ml water per 100 g of the hydrophilic (bio)polymer phase, preferably comprising at least one (bio)polymer, preferably starch; and
optionally at least one compatibiliser.

The sheet may be used for packaging the at least one biological product and dynamically modifying (or maintaining) an atmosphere surrounding said at least one biological product, for example in response to one, two or all of:
the biological activity of the at least one biological product;
the temperature (surrounding the at least one packaged biological product), i.e. storage temperature;
the relative humidity (surrounding the packaged product), e.g. in the direct surrounding of the packaged at least one biological product.

The sheet may suitably be used to delay, extend and/or postpone a ripening process of the at least one biological product.

Accordingly, the present sheet may be used for maintaining a controlled atmosphere surrounding the at least one biological product, wherein for example the concentration of CO₂ is kept below 20, 19, 18, 17, 16, 15, 14, 13, 12, 11, 10, 9, 8, 7, 6, 5, 4, 3, 2 vol. %, and/or above 1, 2, 3 vol. %; and/or wherein the concentration of 02 is kept below 20, 19, 18, 17, 16, 15, 14, 13, 12, 11, 10, 9, 8, 7, 6, 5 vol. %, and/or above 1, 2, 3 vol. %, relative to the total gas composition of the controlled atmosphere.

The present disclosure also provides for the use of the specific (packaging) sheet, i.e. in a method, for at least partially covering at least one biological product during a period having a temperature variation of at least 4° C. and/or relative humidity variation of at least 4%, wherein the sheet comprises or consists of a (thermoplastic) composition with:
a hydrophobic (bio)polymer phase which may have a water absorption capacity of at most 5 ml water per 100 g of the hydrophobic (bio)polymer phase, preferably comprising at least one (bio)polymer preferably polyolefin; and/or
a hydrophilic (bio)polymer phase which may have a water absorption capacity of at least 5 ml water per 100 g of the hydrophilic (bio)polymer phase, preferably comprising at least one (bio) polymer, preferably starch; and
optionally at least one compatibiliser.

The Packaging Material—Sheet

With the term “sheet” is meant an object that is thin in comparison to its length and width (at least in part), e.g. a layer. A sheet can typically cover a significant area with limited material. For example, the sheet may (in part) have a length and/or width of at least 5, 10, 50, 100, 500 cm, while having an (average) thickness of at most 1000, 500, 400, 250, 150, 100, 80, or at most 5, 10, 20, 30, 40, 50, 60 μm. In a preferred embodiment, the sheet is sealable, i.e. capable of being sealed/closed, preferably such that gas can only permeate through the sheet and cannot escape or enter through additional openings, or only to limited extent, e.g. at least 95, 96, 97, 98, 99, or 100 vol % of gas exchange occurs through the sheet and/or at most 5, 4, 3, 2, 1, or 0 vol. % of gas exchange occurs through additional openings. The sheet may comprise multiple layers, for example (at least) 1, 2, 3, 4, or 5 layers, e.g. an (internal) layer, for example one, i.e. the functional layer comprising or consisting of the thermoplastic composition or the hydrophilic polymer phase as defined above, and (at least) 1, 2, 3, or 4 outer layers (for example inner and/or outer side with respect to the biological product) comprising or consisting of said thermoplastic composition, or preferably comprising or consisting of the hydrophobic polymer phase as defined above.

The sheet may be obtained by extruding the (thermoplastic) composition, and subsequently stretching the (thermoplastic) composition (in at least one direction or bi-axially), for example in a machine direction and a transverse direction and/or, preferably, by filling the extruded product with air/gas to stretch it to the desired size (referred to as blown film), at elevated temperature (e.g. above 30, 50, 70, or 90, and/or at most 100, 120, 130, 140, 150, 160, 170, 180, 190, 200° C.). The sheet is then cooled, and optionally flattened.

In a preferred embodiment, the sheet according to the present disclosure is a film with a preferred thickness of between 2-250 μm and/or having a modulus of at least 25, or 50 MPa as measured according to ISO 527 and/or an elongation at break of at least 25%, 50%, 100%, 150%, or 200% as measured according to ISO 527.

The sheet according to the present disclosure preferably has a coefficient of permeability for oxygen of 1-1000 or 5-750, 10-500 or 50-150 mIO₂/m₂.day.atm when stored at 23° C. and 0% RH or at storage at 23° C. and 85% RH: 500-3000, or 750-2500 or 1000-2000 mIO₂/m₂.day.atm as measured according to ASTM D-3985 (100% O₂) on a sheet with a thickness of 100 μm.

The sheet according to the present disclosure preferably has a coefficient of permeability for water vapour of at most 100, more preferably at most 75, most preferably at most 50 (g/m²*day) as measured according to ASTM E-96 (23° C., 90% RH) on a sheet with a thickness of 100 μm.

The sheet according to the present disclosure may further comprise an additional (thermoplastic) polymer layer (or film) comprising a fossil-based polymer or (bio)polymer which may also extend in machine direction and transverse direction, such as an inner and/or an outer side (e.g. with respect to the biological product) of the present sheet is provided with such a film. The (bio)polymer or fossil-based polymer can be a polyolefin, for example polyethylene. This may be applied as an extra variable to reduce water sensitivity of various properties. The further sheet can be provided by means of lamination or co-extrusion before or after stretching in machine direction and transverse direction.

The (packaging) sheet according to the present disclosure may be in the form of a bag, or cover sheet or part of a larger packaging. For example, a packaging is foreseen comprising at least or at most 10, 20, 30, 40, 50, 60, 70, 80, 90, 95, 100 wt. % or surface % of the packaging sheet according to the present disclosure. In this embodiment, the part of the packaging which is according to the present disclosure can be seen as the dynamic part of the packaging which actively adapts to e.g. respiration rate of the packaged biological product and/or varying surrounding temperature/humidity.

In other words, the present sheet may at least partially define an outer surface of a (closed) modified atmosphere that at least partially or wholly surrounds the at least one biological product, preferably wherein the sheet defines between 1-100%, 1-80%, 1-60%, 1-40%%, 1-20%, or 20-100%, 40-100%, 60-100%, 80-100% of said outer surface, the remainder being defined by another packaging material.

The Packaging Material—Multilayer

The sheet according to the present disclosure preferably has a layered morphology on 2 levels: the sheet comprises an internal or functional layer which may be coated with an outer layer. For example, the sheet can be a multilayer sheet, e.g. comprising (at least) 2, 3, 4, or 5 layers, and/or wherein two outer layers are made of a composition to reduce/regulate the water sensitivity of an inner layer comprising the thermoplastic composition according to the present disclosure, i.e. a mix of hydrophobic polymer phase and hydrophilic polymer phase. In this way, one can adjust the permeability properties of the sheet. As such composition one may also use the thermoplastic composition according to the present disclosure wherein preferably the hydrophilic polymer phase is excluded. One or more layers can be tie layers to adhere other layers to each other.

The sheet according to the present disclosure and/or the functional layer thereof preferably comprises separate and/or alternating layers of hydrophilic polymer phase and hydrophobic polymer phase, wherein said layers of hydrophilic polymer phase and hydrophobic polymer phase may extend along the length and/or width of the sheet, such as in machine direction as well as in transverse direction.

The term layered morphology of the internal or functional layer with alternating layers as used herein preferably is a morphology wherein layers of hydrophilic polymer phase and hydrophobic polymer phase can be observed predominantly as alternating stacked formations seen in machine direction and transverse direction and wherein the layers extend in length and width of the sheet, meaning that the layers of polyolefin and hydrophilic polymer are not a mere combination of isolated domains in these directions. Of course, isolated domains of hydrophilic polymer and/or polyolefin may nevertheless be present. Such isolated domains will typically be present as a minor part of the sheet, typically in an amount less than 5,10, 20, 30,40, 50, 60, 70, 80, 90, 100 wt %.

In a typical embodiment, the (functional layer of the) sheet according to the present disclosure comprises
between 10-80 wt. % of the at least one hydrophobic polymer phase;
between 10-80 wt. % of the at least one hydrophilic polymer phase; and/or
between 1-40 wt. % of the at least one compatibiliser.

The sheet according to the present disclosure typically has a (nano) multi-layer structure of e.g. hydrophilic polymer phase and hydrophobic polymer phase, without the need for a multilayer lamination or a co-extrusion step.

The (functional layer in the) present sheet and/or (thermoplastic) composition may alternatively comprise
between 10-80 wt % of the hydrophobic polymer, e.g. polyethylene, preferably low density polyethylene, or between 20-80 wt % of a thermoplastic polyester, preferably poly(butylene terephthalate-co-adipate);
between 10-80 wt % of the hydrophilic polymer, e.g. thermoplastic starch; and/or
optionally between 1-40 wt % of at least one compatibiliser such as a partially hydrolysed and/or saponified polyvinylacetate as herein disclosed,

wherein the weight percentages in the present disclosure are based on the total weight of the composition or sheet unless otherwise indicated.

The layer thickness (i.e. the thickness in Z direction) of the functional layer may be between 0.1-100 μm, and/or the thickness of the outer (polyolefin) layer(s) may be between 0.1-100 μm (for example one or two outer layers). Preferably said layers are at most 75 or at most 50, 40, 35, 30, 25, or 20 μm. Thickness can be measured by means of electron microscopy.

The Packaging Material—Use

As explained herein, the sheet can be used for packaging biological products, thereby extending their shelf-life, i.e. extending the period in which the products remain of good quality and thus fit for consumption, and/or saleable. For example, the sheet can be used to pack biological products (fruit, vegetable or ornamentals) inside the (sealed) sheet. In the first days, the packaging and the relative humidity inside the package are still relatively low, so the OTR and CTR properties of the sheet are also remaining low; meaning that the oxygen content in the packaging headspace drops faster and the equilibrium modified atmosphere (targeted oxygen and carbon dioxide contents) are reached faster. Later on during the storage period, the relative humidity typically increases and the OTR and CTR of the sheet increase also. In this way, fermentation conditions can be avoided and off-taste/off-odour are minimized compared to standard modified atmosphere packaging.

The biological product can be any type of product that is produced by a living organism and/or may contain at least 1, 5, 10, 20 or 40 wt. % living biological cells. The biological product preferably has a minimum respiration rate of 5 ml CO₂/kg/hour at a storage temperature of 5° C. (“Postharvest biology and Technology: an overview”: (A. A. Kader) PP:39-47 of book Postharvest technology of horticultural crops, 3^{rd} edition (2002) ISBN 1-879906-51-1). Preferably, the biological product is a horticultural product and/or may be chosen from the group consisting of fruit, vegetable, flower (bulb), and/or ornamental (plants). Typically, the biological product is a fresh product, i.e. has its original qualities unimpaired and/or is within at most 12, 11, 10, 9, 8, 7, 6, 5, 4, 3, 2, 1 months or 4, 3, 2, 1 week from harvest.

Specifically, the biological product may refer to (tropical) fruit, preferably pear, strawberry, apple, (green) banana, avocado and/or mango; vegetable, preferably lettuce; fresh cut fruit or vegetable; mushroom; ready meal (or ready to cook) and/or salad; potato; flower(bulb), preferably cut flower, more preferably chrysanthemum and/or carnation (Dianthus caryophyllus); and/or with lesser preference coffee, meat, wood, cheese, and/or bread.

As disclosed herein before, there is provided for the use of the (packaging) sheet for at least partially covering at least one biological product during a period having a temperature variation of at least 1, 2, 3, or 4° C., preferably at least 5, 6, 7, 8, 9, 10, 11, 12, 13, 14, 15, 20, or at least 25° C. and/or having a relative humidity variation of at least 1, 2, 3, 4, 5, 6, 7, 8, 9, 10, 11, 12, 13, 14, 15, 20, or 25, 30, 35, 40, 45, even at least 50%. With “temperature variation” or “relative humidity variation” is meant the difference between the lowest and highest temperature/relative humidity value in the respective period, in the space where the sheet and/or biological product resides, preferably the space surrounding the packaged biological product. Relative humidity may for example be measured by means of a hygrometer (e.g. Hygrometer PCE-HVAC 3 from PCE Instruments). The period may be at least 2, 4, 6, 8, 10, 12, 14, 16, 18, 20, 22, 24, 26, 28, 30, 32, 34, 36, 38, 40 days, such as during transport of the at least one biological product.

The sheet according to the present disclosure allows to keep the packaged biological product under a controlled (or modified) atmosphere, even in case of temperature and/or relative humidity changes within the period wherein the biological product is packaged.

For a typical biological product, the concentration of CO₂ in the modified atmosphere is preferably kept below 24, 22, 20, 18, 17, 16, 15, 14, 13, 12, 10, 8, 6, 5 or 4, 3, 2, 1 vol. % with respect to the total volume of the packaging headspace and/or the concentration of 02 in the modified atmosphere is preferably kept above 0.2, 1, 2, 3, 4, 5, 6, 7, 8, 9, 10, 12, 14,16, 18 vol. % with respect to the total volume of the packaging headspace.

The sheet according to the present disclosure allows to keep such an ideal controlled atmosphere for biological products having different respiration rates and/or respiration profiles (in relation to temperature/relative humidity). For example, this is achieved by tailoring the amount of outer surface of the (closed) modified atmosphere that the sheet defines, and using another sheet or means that defines the remaining outer surface.

Biological products with relatively high respiration rates, such as avocado, blackberry, carrot, cauliflower, leek, lettuce, lima bean, radish, raspberry, strawberry, particularly artichoke, bean sprouts, broccoli, brussels sprouts, cherimoya, cut flowers, endive, green onions, kale, okra, passion fruit, snap bean, watercress, most particularly asparagus, mushroom(s), parsley, peas, spinach, and/or sweet corn a larger amount of said outer surface (e.g. at least 40, 50, 60, 70%) may be defined by the present sheet (and another sheet or means that defines the remaining outer surface), while biological products with relatively low respiration rates, such as apple, beet, celery, citrus fruits, cranberry, garlic, honeydew melon, kiwifruit, onion, papaya, persimmon, pineapple, pomegranate, potato, pumpkin, sweet potato, watermelon, winter squash, particularly dates, dried fruits and vegetables, nuts and/or grape(s) a smaller amount of said outer surface (e.g. at most 40, 50, 60, 70%) may be defined by the present sheet (and another sheet or means that defines the remaining outer surface). For biological products with medium respiration rates, such as apricot, banana, blueberry, cabbage, cantaloupe, carrot, celeriac, cherry, cucumber, fig, gooseberry, lettuce, mango, nectarine, olive, peach, pear, plum potato, radish, summer squash, and/or tomato, a medium amount of said outer surface (e.g. between 30 and 70%, or between 40 and 60%) may be defined by the present sheet, the remainder being defined by another sheet or means.

The thickness of the sheet and/or one or more (both) of its outer layers can be tailored to the specific biological product to be packaged and/or tailored to the length of the period wherein the biological product is packaged. For example, thinner outer layer(s) of the sheet are foreseen, for example at most 2, 5, 10, 20, 30, 40, 50 μm and/or at most 2, 5, 10, 20, 30, 40, 50, 60, 70, 80% of the thickness of the sheet as a whole, typically suitable in the case of a biological product with high respiration rate. In between the outer layers can the thermoplastic composition with hydrophilic polymer phase, a hydrophobic polymer phase and optionally a compatibilizer be situated.

Also, a thicker outer layer(s) of the sheet are foreseen, for example at least 10, 20, 30, 40, 50, 60, 70, 80, 90, 100 μm and/or at least 10, 20, 30, 40, 50, 60, 70, 80, 90, 100% of the thickness of the sheet as a whole, typically suitable in the case of a biological product with low respiration rate.

Alternatively or additionally, a thicker sheet and/or thicker outer layer(s) are foreseen, for example at least 20, 30, 40, 50, 60, 70, 80, 90, 100 μm and/or at least 20, 30, 40, 50, 60, 70, 80, 90, 100% of the thickness of the sheet as a whole, typically suitable in the case of a longer period wherein the biological product is covered or packaged by the present sheet (e.g. at least 8, 10, 12, 14, 16, 18, 20, 24, 28 days). Alternatively, a thinner sheet and/or thinner outer layer(s) are foreseen, for example at most 10, 20, 30, 40, 50, 60 μm and/or at most 10, 20, 30, 40, 50, 60% of the thickness of the sheet as a whole, typically suitable in the case of a shorter period (e.g. at most 4, 6, 8, 10, 12, 14, 16 days). This is due to moisture saturation in the sheet over time. In general, the thickness of the sheet can be between 1-50 μm, 5-40 μm, 5-30 μm, 20-60 μm, 50-100 μm, or 70-100 μm.

Additionally and/or alternatively, the amount of hydrophilic polymer phase in (the internal/functional layer of) the sheet can be tailored to the specific biological product to be packaged, so as to adapt for its specific respiration rate and/or respiration profile (in relation to temperature). A larger amount of hydrophilic polymer phase can be used in the sheet (e.g. at least 30, 40, 50, 60, 70, 80 wt %) typically suited for biological products with relatively high respiration rates. Alternatively, a smaller amount of hydrophilic polymer phase can be used in the sheet (e.g. at most 5, 10, 20, 30, 40, 50, 60 wt %), typically suited for biological products with relatively low respiration rates. Alternatively, a medium amount of hydrophilic polymer phase can be used in the sheet (e.g. between 30-70 or 40-60, 5-50, 10-40 wt %), typically suited for biological products with medium respiration rates.

The thermoplastic composition according to the present disclosure, or the sheet according to the present disclosure (or a middle layer thereof) may contain between 1-50, 1-25, 1-10, 35-90, 40-80, 40-75, 50-90 wt. % of the hydrophilic polymer phase.

As will be clear, the present disclosure also provides for a biological product in combination with, or (partly) packaged in/with, at least one sheet comprising or consisting of a thermoplastic composition with:
a hydrophobic polymer phase which may have a water absorption capacity of at most 5 ml water per 100 g of the hydrophobic polymer phase, wherein the hydrophobic polymer phase preferably is a (thermoplastic) polyolefin phase and/or comprises at least one (thermoplastic) polyolefin;
a hydrophilic polymer phase which may have a water absorption capacity of at least 5 ml water per 100 g of the hydrophilic polymer phase, wherein the hydrophilic polymer phase preferably is or comprises starch, more preferably thermoplastic starch; and
optionally at least one compatibiliser.

It will be clear that the sheet according to the present disclosure typically is not edible, and/or not applied as a coating, i.e. following the shape of at least 50, 60, 70, 80, 90, 95, or 100% of the surface of the biological product. In this regard, the present sheet is preferably not attached to the surface of the packaged/covered product, e.g. at least 50% of the surface area, such as by means of adhesion. In this regard, there preferably is space between the sheet and the packaged product, such as at least 1, 2, 3, 4, 5, 10, 15, 20, 50, 100, 1000 cm³. The present sheet preferably does not need a substrate to maintain its integrity, firmness and/or structure, in contrast to a coating. The present sheet further preferably cannot be washed away with water.

The Thermoplastic Composition—General

The (thermoplastic) composition can be any polymer-comprising composition, for example a composition comprising at least 40, 60, 80, 95, 99, or 100 wt. % polymer(s), i.e. molecules composed of at least 2, 10, 100, 500, 1000 subunits. In this regard, thermoplastic refers to the property of being pliable or moldable above a certain temperature (e.g. above 30, 50, 70, or 90, and/or at most 100, 120, 130, 140, 150, 160, 170, 180, 190, 200° C. and without change of the inherent properties) while solidifying below such temperature. Preferably, the thermoplastic composition has a viscosity of at least 100, 1000, 10⁴ or even 10⁵, 10⁶ mPa·s and/or at most 10⁵, 10⁶, 10⁷ 10⁸ or 10⁹ mPa·s at or above (melt) temperature of e.g. 70, 90, 100, 120, 130, 140, 150, 160, 170, 180, 190 or 200° C. Viscosity/shear rate relations can be analysed using a Rosand RH7 dual bore Advanced Capillary Extrusion Rheometer. Speeds of the piston can be set from 1 mm/min to 150/mm/min. When equipped with e.g. a capillar of 16×1 mm viscosities in the shear rate range of 40 to 3000 s⁻¹ can be determined. Viscosity itself can be deduced by help of a pressure transducer placed just before the entrance of the capillar. Prior to analysing, the machine has to be filled with about 50 grams of material, next the sample needs to be heated/melted at the measuring temperature for 6 minutes. After this the analysis can start.

In the present disclosure, the term “hydrophobic” or “hydrophilic” preferably refers to a certain minimum or maximum water absorption capacity such as at least 5, 10, 30, 50, 70, 90, 120 ml or at most 5, 4, 3, 2, 1 ml water per 100 g of the respective polymer or phase/composition. Alternatively, a polymer (phase) can be regarded hydrophobic in case its water solubility is below 100, 75, 50, 25, 10, 5, 1, 0.5, 0.1 g/L, and hydrophilic in case its water solubility is above 0.1, 0.5, 1, 5, 10, 25, 50, 75, 100 g/L. Generally, hydrophilic polymers contain polar groups (e.g. (—OH, ═NH, =C═O, —C(O)OH, —CN, —C—O—C—, —C—N—C—) or charged functional groups, while hydrophobic polymers typically do not. Further, hydrophilicity/hydrophobicity may be characterized by a contact angle of at least 40°, 50°, 60°, 70°, 80°, 90° (hydrophobic) or at most 80°, 70°, 60°, 50°, 40°, 30° (hydrophilic) according to the captive bubble method, determined for a sheet made of the polymer (phase) to be tested. The captive bubble method is well-known to the skilled person and involves measuring the contact angle between e.g. a 2 μL water drop and the surface using drop shape analysis. For example, by using a video-based optical contact angle meter OCA 15 (DataPhysics Instruments GmbH, Filderstadt, Germany). Water contact angle can be determined by applying an water bubble (2 μL) on the sheet using an electronically regulated Hamilton syringe and needle. The contact angle can be calculated using SCA20 software (DataPhysics Instruments GmbH, Filderstadt, Germany).

Water absorption capacity can be measured for example by using the method of ISO 62 (Determination of water absorption). For example, 100 g of the at least one polymer phase, to be assessed for its water absorption capacity, can be immersed in water for 24 hours (e.g. after drying it in an oven at 50° C.)), and the volume of the water absorbed is measured.

In this way, the water absorption capacity of the at least one polymer phase can be calculated.

Alternatively, a test sheet comprising 100 g of the at least one polymer phase, to be assessed for its water absorption capacity, and a reference sheet of equal weight but not comprising said at least one polymer phase can be both immersed in water for 24 hours (e.g. after drying it in an oven of 50° C.), and the volume of the water absorbed is measured for both test sheets. In this way, the water absorption capacity of the at least one polymer phase can be calculated.

In a preferred embodiment, the (thermoplastic) composition according to the present disclosure comprises a hydrophilic polymer phase and a hydrophobic polymer phase in a weight ratio of between 0.1-9, 0.4-4, preferably from 0.6-3.

The Thermoplastic Composition—Hydrophobic Polymer Phase

As mentioned above, the composition comprises a hydrophobic polymer phase, preferably biopolymer phase or polyolefin phase, which may constitute 1-100, 1-80, 1-50, 1-25, 1-10, 25-60, 40-80, 75-99, 50-99, 50-90 wt. % of the composition. As will be clear, the optional remainder being other constituents.

The hydrophobic polymer phase may comprise at least one (bio) polymer, for example in an amount of at least 20, 40, 60, 80, or 100 wt. % of the phase, which may be chosen from the group consisting of polybutylene succinate (PBS), poly(butylene terephthalate-co-adipate) (PBAT), polylactic acid (PLA), poly-3-hydroxybutyrate (P3HB), and polycaprolactone (PCL). Preferably, the at least one (bio) polymer has a water absorption capacity of at most 10, 8, 6, 5, 4, 2, 1, 0.5, 0.2 ml water per 100 g of the at least one (bio) polymer, i.e. as comprised in the hydrophobic polymer phase. The term biopolymer is used herein to make clear that the polymer can be (partly) plant-based or (partly) made from plant materials and/or that the polymer is biodegradable, preferably as defined in European Standard EN 13432, i.e. determined by measuring the actual metabolic conversion of the polymer material into carbon dioxide. This property is quantitatively measured using the standard test method, EN 14046 (which is also published as ISO 14855: biodegradability under controlled composting conditions). The level for being biodegradable must be at least 90%, and reached in less than 6 months.

The at least one (bio)polymer may also be present in an amount of at least 10, 30, 50, 70, or 90 wt. % of the hydrophobic polymer phase, and may be polyester, preferably chosen from the group consisting of polybutylene adipate terephthalate and polybutylene succinate or its copolymers, or a polyolefin, preferably chosen from the group consisting of polyethylene, polypropylene, polymethylpentene, polybutene-1, and polystyrene. Preferably, the at least one hydrophobic polymer has a water absorption capacity of at most 10, 8, 6, 5, 4, 3, 2, 1, 0.5, 0.2, 0.1 ml water per 100 g of the at least one hydrophobic polymer.

In case a polyolefin is used in the present disclosure as the hydrophobic polymer, it is preferably (high density) polyethylene, medium density polyethylene, low density polyethylene, linear low density polyethylene and mixtures thereof, such as of at least two of thereof.

It is preferred that the density of the polyolefin is chosen to be at least 0.5, 0.6, 0.7, 0.8, or at least 0.910 g/cm³. The sheet and/or the (thermoplastic) composition may further, or as alternative to the polyolefin, comprise a thermoplastic polyester, such as poly(butylene terephthalate-co-adipate), e.g. in an amount of between 20-80 wt % based on the sheet or thermoplastic composition, and/or preferably in combination with a partially hydrolysed saponified polyvinylacetate as compatibiliser, such as disclosed in U.S. Pat. No. 6,958,369. The polyester can form a co-continuous morphology together with any thermoplastic starch so that the starch phase comprises the thermoplastic starch, the thermoplastic polyester and compatibiliser. This may result in a less polar starch phase which makes compatibilisation with the non-polar polyolefin phase easier. A further compatibiliser such as a polyolefin, preferably polyethylene, e.g. with at least 1wt % and preferably at most 10 wt % maleic anhydride grafted thereon may be used to increase desired adhesion.

Additionally and/or alternatively, the present sheet may further comprise a thermoplastic polyester, preferably poly(butylene terephthalate-co-adipate) in an amount of from 20 to 80 weight %.

The Thermoplastic Composition—Hydrophilic Polymer Phase

The hydrophilic polymer phase may comprise at least one (bio) polymer, for example in an amount of at least 10, 20, 30, 40, 50, 60, 70, 80, 90 or 100 wt. % of the phase, and the hydrophilic polymer phase may have a water absorption capacity of at least 1, 2, 3, 4, 5, 6, 7, 8, 9, 10, 15, 20, 25, 30, 35, 40, 45, 50, 55, 60, 65, 70, 75, 80, 85, 90, 95 or 100 ml water per 100 g of the hydrophilic polymer phase. Preferably, the at least one (bio) polymer has a water absorption capacity of at least 0.2, 0.5, 1, 2, 4, 5, 6, 8, or 10 ml water per 100 g of at least one (bio)polymer i.e. as comprised in the hydrophilic polymer phase. As will be clear, the optional remaining wt % in the phase may be other constituents.

In a particularly preferred embodiment, the at least one (bio, or fossil-based) polymer for use in the hydrophilic polymer phase is a carbohydrate or a protein, preferably chosen from the group consisting of wheat gluten, wheat flour, chitosan, pullulan, pectin, myofibrillar protein. Any of these may be used in native form or chemically modified form.

More preferably, the hydrophilic polymer is starch, i.e. a polymeric carbohydrate consisting of a large number of glucose units joined by glycosidic bonds, and preferably is thermoplastic starch. Thermoplastic starch can be obtained by converting native and/or chemically modified starch by melt processing with one or more plasticisers. For example, polyhydric alcohols may be used as plasticisers in the manufacture of thermoplastic starch.

The (thermoplastic) starch as preferably applied in the present disclosure as the (hydrophilic) polymer may be made or derived from any starch source including corn, tapioca, maize, wheat, rice, potato, soy bean or any mixture or combination of at least two of these starch sources, while potato starch is particularly preferred. Starch typically comprises amylose, a linear polymer with molecular weight of about 1×10⁵-1×10⁶ and amylopectin, a branched polymer with very high molecular weight of the order 1×10⁷. Each repeating glucose unit typically has three free hydroxyl groups, which provides the polymer with the hydrophilic properties as envisaged herein.

The ratio between hydrophilic polymer and hydrophobic polymer in the functional layer (i.e. middle layer), e.g. the ratio between starch and PE, may be between 5-40 to between 95-60, preferably between 1-30 to between 99-60, more preferably 3-20 to between 97-80, or between 1-15 to between 99-85. Alternatively, the ratio between PE and starch may be between 5-40 to between 95-60, preferably between 1-30 to between 99-60, more preferably 3-20 to between 97-80, or between 1-15 to between 99-85.

The starch structure may be adjusted (i.e. in the functional layer). For example, the starch composition comprises at least 10, 25, 40, 50, 75, 80, 90, or 100 wt. % (and/or at most 40, 30, 20 wt. %) monobranched starch and/or at least 10, 25, 40, 50, 75, 80, 90, or 100 wt. % (and/or at most 40, 30, 20 wt. %) multi-branched starch.

In addition or alternative to a native form of starch, it is also envisaged that a chemically modified starch is used in the present disclosure. Chemically modified starch includes oxidized starch, etherificated starch, esterified starch or a combination thereof (e.g. etherificated and esterified starch). Suitable etherificated starch may include starch that is substituted with ethyl and/or propyl groups, while suitable esterified starch may include starch that is substituted with actyl, propanoyl and/or butanoyl groups.

Chemically modified starch can be prepared by reacting the hydroxyl groups of starch with reagents. The degree of substitution (DS), can alter the physiochemical properties of the modified starch compared with the corresponding native starch, including considerably different hydrophilic/hydrophobic properties.

A thermoplastic starch, as preferably use as the hydrophilic polymer in the present disclosure, may comprise one or more polyhydric alcohol plasticisers. Suitable polyhydric alcohols include ethylene glycol, ethylene di-glycol, propylene di-glycol, propylene glycol, ethylene tri-glycol, polyethylene glycol, polypropylene glycol, 1,2-propanediol, 1,3-propanediol, 1,2-butanediol, propylene tri-glycol, 1,3-butanediol, 1,4-butanediol, 1,5-pentanediol, 1,6-hexanediol, 1,5-hexanediol, 1,2,6-hexanetriol, 1,3,5-hexanetriol, neo-pentyl glycol, pentaerythritol, mannitol, sorbitol, trimethylol propane, and the acetate, ethoxylate, and propoxylate derivatives thereof.

In a preferred embodiment the thermoplastic starch may comprise glycerol and/or sorbitol plasticisers. The plasticiser content within thermoplastic starch may be between 5 wt % and 65 wt %, or between 10 wt. % and 60 wt % or between 10 wt. % and 55 wt %, relative to the combined mass of the starch and plasticizer(s).

Although the present disclosure preferably uses starch as a component of the sheet, it is not excluded to use flour instead of starch, since starch is a major constituent of flour.

Thermoplastic Composition—Compatibiliser

The term compatibiliser as used herein can be understood as being a material having affinity with both the hydrophilic polymer (e.g. starch) phase and the hydrophobic polymer phase and which material is able to improve the adhesion of these two phases at their interface.

The compatibiliser may be used to enhance the bond between the hydrophilic polymer phase (e.g. starch) and the polyolefin phase. The compatibiliser may be selected from block or graft copolymer, nonreactive polymers containing polar groups and/or reactive functional polymer, more preferably selected from the group consisting of ethylene vinyl acetate copolymers, partially hydrolysed and saponified polyvinylacetate, polyolefins having at least 1 wt % maleic anhydride grafted thereon, ethylene vinyl alchol copolymers, ethylene acrylic acid copolymers, random terpolymers of ethylene, acrylic esters and maleic anhydride or mixtures thereof.

Examples of compatibilisers are block copolymers having polar and non-polar monomers, and maleic anhydride grafted polyolefins. The compatibiliser will typically not form a separate phase in the sheet.

The compatibiliser may also be a polymer material having a non-polar backbone and a polar group incorporated in the backbone or grafted thereon. Such a polar group may be reactive with respect to the hydrophilic polymer (e.g. starch) and react with at least a part of thereof.

Suitable compatibilisers include ethylene vinyl alcohol copolymers, ethylene acrylic acid copolymers, ethylene vinyl acetate copolymers, polyolefins having at least 1 wt % maleic anhydride grafted thereon, random terpolymers of ethylene, block saponified polyvinyl acetate, butylacrylate and maleic anhydride, random, (partially hydrolysed and saponified) polyvinylacetate or mixtures therefor such as of at least two of these compatibilisers.

A suitable partially hydrolysed and saponified polyvinyl acetate can be obtained by the method as described in U.S. Pat. No. 6,958,369. Briefly, this partially hydrolysed and saponified polyvinyl acetate is obtained by
hydrolyzing and saponifying polyvinyl acetate in the presence of catalytic additions of low-molecular organic mono-, di- and trihydroxyl compounds (e.g. methanol, ethanol, ethylene glycol, glycerol),

with a continuous addition of basically reacting compounds and an alkali silicate.

Specifically, the process for producing a partially hydrolysed and saponified polyvinyl acetate can comprise
providing an aqueous dispersion of polyvinyl acetate;
adding a catalyst, such as selected from the group consisting of mono-hydroxy compounds, di-hydroxy compounds and tri-hydroxy compounds, to the aqueous dispersion;
preferably presaponifying (until a degree of presaponification of 10% to 40% has been reached) the aqueous dispersion of polyvinyl acetate by adding an alkaline substance (such as calcium hydroxide) to the aqueous dispersion (until a degree of hydrolysis of 10% to 40% is reached);
providing an alkali silicate solution;
reacting (until a final degree of hydrolysis of 30% to 85% is reached) in a mixer the presaponified polyvinyl acetate with the alkali silicate solution by adding, while stirring, the alkali silicate solution to the presaponified polyvinyl acetate over a period of at least one hour to form organosilicates, wherein a combined water content of the presaponified polyvinyl acetate and of the alkali silicate solution is more than 40%.

The amount of compatibiliser in the (thermoplastic) composition and/or in the sheet is preferably between 1-30 wt. %, 2-10 wt. % or 3-25 wt. % based on the thermoplastic composition or the sheet.

Processing

The sheet according to the present disclosure can be produced by providing a (thermoplastic) composition comprising at least one polyolefin, thermoplastic starch and at least one compatibiliser and subsequently introducing said thermoplastic composition into an extruder, and extruding it through an extrusion die and stretching the thermoplastic composition by exiting the extrusion die at elevated temperature in at least one direction , e.g. in machine direction and transverse direction.

In an embodiment, the thermoplastic composition is introduced into the extruder in the form of pellets which can be prior prepared in a separate extrusion process. It is also possible that the sheet is prepared by introducing a polyolefin or a mixture of two or more polyolefins, starch, and optionally at least one processing aid for making thermoplastic starch and preferably at least one compatibiliser to an extruder, extruding said under conditions such that a thermoplastic composition comprising at least one polyolefin, thermoplastic starch and optionally at least one compatibiliser is formed in the extruder and subsequently stretching the thermoplastic composition by or upon exiting the extruder at elevated temperature, via an extrusion die in at least one direction, e.g. in machine direction and transverse direction.

The starch that is used in the present disclosure is preferably used as such and is not necessarily dried or otherwise treated before being processed to thermoplastic starch. The temperature during the extrusion into sheet preferably does not exceed 180° C., more preferably it stays below 160° C. During exiting the extrusion die, the thermoplastic composition is preferably at most 130° C.

Preferably a stretch ratio in transverse direction is at least 1.5, preferably at least 2, 3, 4, or 5 wherein said stretch ratio can be defined as:

$$S {R}_{t d} = \frac{{W}_{1}}{{W}_{0}}$$

and/or a stretch ratio in machine direction is at least 1.5, or 2, 3, 4, 5, 10, 15 wherein the stretch ratio in machine

direction is defined as:

$$S {R}_{m d} = \frac{{T}_{0}}{{T}_{1} \times S {R}_{t d}}$$

wherein

SR_{md}=stretch ratio in machine direction

SR_{td}=stretch ratio in transverse direction

Wₒ=width of the thermoplastic composition before stretching in transverse direction [mm]

W₁=width of the biaxially stretched sheet [mm]

Tₒ=thickness of the thermoplastic composition before stretching in machine and transverse direction [mm]

T₁=thickness of the biaxially stretched sheet [mm]

It is further preferred that the stretch ratio in machine direction is at most 20, 15 or 10, while the stretch ratio in transverse direction is preferably at most 6, 5, 4, 3, 2.

The present disclosure is not limited to a specific stretching process, but it is preferred to use a film blowing technique or a film casting technique (e.g. stretching in at least one direction) or a biaxial stretching process within a Tenter frame, such as techniques suitable for making thin films. Other stretching techniques such as calendering can also be applied but are not preferred.

In this document and in its claims, the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

### BRIEF DESCRIPTION OF THE FIGURES

FIG. 1: CO₂ and O₂ concentration (vol. %) within three different packaging bags with Conference pears after 5 days at 8° C. (t1), or after 5 days at 8° C.+5 days at 18° C. (t2). Bag A: Macro-perforation bags; Bag B: Micro-perforation bags; Bag C: Starch based bags. Light grey: oxygen content (%), darker grey: carbon dioxide content (%). Standard deviation, (N=5).

FIG. 2: Oxygen concentrations were measured in packaging materials according to the disclosure and a reference material, on day 0, 2, 5, 7, and 9 upon packaging pears.

FIG. 3: Carbon dioxide concentrations were measured in packaging materials according to the disclosure and a reference material, on day 0, 2, 5, 7, and 9 upon packaging pears.

FIG. 4: Oxygen concentrations were measured in packaging materials according to the disclosure and a reference material, on day 0, 2, 5, 7, and 9 upon packaging mushrooms.

FIG. 5: Carbon dioxide concentrations were measured in packaging materials according to the disclosure and a reference material, on day 0, 2, 5, 7, and 9 upon packaging mushrooms.

FIG. 6: Photos showing mushroom quality after 5 days at 5 degrees Celsius and 4 days at 18 degrees Celsius, packaged in packaging materials according to the disclosure and a reference material.

### EXAMPLE 1

Production of Starch/Polyethylene Film

Manufacturing of the hydrophilic/hydrophobic film is performed in 2 steps:
1. production of a thermoplastic composition with a hydrophilic polymer phase, a hydrophobic polymer phase and a compatibilizer
2. production of a film out of the thermoplastic composition

ad 1: A powder/fluid mixture comprising:
32.15% native potato starch (type Emsland Superior; 17% moisture content) (=hydrophilic polymer)
1.2% borax (type: Borax 10H2O GR Turkey obtainable from Brenntag)
1.2% fatty acid mixture (type Radiacid 0436, obtainable from Oleon)
0.6% glycerol mono stearate (type Radiasurf 7142 GMS, obtainable from Oleon)
0.24% sodium carbonate (type sodium carbonate anhydrous light Food (E500i) from Brenntag)
27.3% glycerol (type glycerine vegetable Pharm. (E422), obtainable from Brenntag)
32.76% LDPE (type Sabic LDPE 2008TN00) (=hydrophobic polymer)
4.55% compatibilizer (type Lotader 3410, obtainable from Arkema)

was compounded on a Berstorff ZE 40 A*38 D twin screw extruder equipped with a GALA LPU underwater pelletizer. Temperature profile along the barrel was: zone 1: 25° C.; zone 2: 60° C.; zone 3: 135° C.; zone 4: 160° C.; zone 5: 160° C.; zone 6: 160° C.; zone 7: 110° C.; zone 8: 95° C.; LPU: 120° C. Screw speed was 225 rpm. Total throughput was 26 kg/h. The compound was pelletized with help of the underwaterpelletizer (pellet size was about 4 mm) and dried to a moisture content of 3.7%.

Ad 2: Starch/LDPE compound was processed into a symmetrical 3 layer film with help of a BFA/Battenfeld coextrusion multilayer (max=5) film blowing machine. Machine consisted out of a Battenfeld UNI-Ex 1-45-25B (central layer) and a BFA 30-25 extruder (for both coating layers) attached to a Battenfeld BK 50/150-05 multi spiral mandrel die. Central layer consisted out of the pelletized material as described under Ad 1. Both coating layers consisted out of a dry blend of 60% Sabic LDPE 2404, 30% Sabic LLDPE 6318 and 10% Lotader 3410. Layer distribution was: coating/central layer/coating=25/50/25. Processing temperatures was about 130° C. for the central layer and 145° C. for both coating layers. Total throughput was 18 kg/h. Film thickness was about 55 micron. Stretch ratio in transverse direction is between 3 and 4. Stretch ratio in machine direction is between 8 and 9.

Pear Packaging Tests

The pear packaging tests were repeated two times: one time in 2016 and one time in 2017. In both cases, Dutch conference pears were used. These pears were first stored for a period of 6 months at low temperature (−0.5° C.) and under control atmosphere conditions, followed of 6 weeks of transport simulation (at −0.5° C. under atmospheric gas conditions). Both experiments showed clear advantage of the starch-based foils compared to the reference pears (non-packed or with macro-perforation) and/or packed in packaging with micro-perforation.

1^{st} Test:

Once the pears were packed, they were stored 5 days at 8° C. followed of 6 days at 18° C. The reference (ref) treatment consisted BOPP (biaxially oriented polypropylene) film with two macro-perforation (7 mm diameter, 19*21 cm). The micro-perforation treatment (bag 2) was made with bag of BOPP material (30 μm thick, 19*21 cm) with 8 micro-perforations per bag (100 μm diameter). The starch-based packaging (bag 3) was made of similar dimension: 19×21 cm (total film area: 800 cm²). All the bags were closed on day 0 with atmospheric gas (20.8% O2 and 0% CO2).

TABLE 1
Quality attributes of pears after unpacking

| | Firmness (kg) | Colour (1-4) |
|---|---|---|
| ref | 1.11 ± 0.07 | 3.44 ± 0.05 |
| bag 2 | 1.56 ± 0.12 | 2.69 ± 0.04 |
| bag 3 | 3.58 ± 0.36 | 2.63 ± 0.07 |

TABLE 2
Headspace composition of used packaging films

| | | Carbon |
|---|---|---|
| | Oxygen | dioxide |
| | (%) | (%) |
| ref | 20.4 | 0.44 |
| bag 2 | 14.8 | 5.58 |
| bag 3 | 1.4 | 5.73 |

In the bag 3 (starch-based film), the oxygen content was lower and the carbon dioxide content was limited to 5.73% (Table 2), which content did not cause any internal quality damages. Thanks to this modified atmospheric gas conditions, the pears packed in starch-based foil stayed firmer (3.58 kg versus 1.11 and 1.56 kg for reference film and micro-perforated film respectively) and remained more green(Table 1).

2^{nd} Test:

In pear packaging tests, fresh pears were packed in different sheets (bags) and stored for a period of 5 days at 8° C., or after 5 days at 8° C.+5 days at 18° C., in order to simulate real chain distribution conditions (increased temperature at the end of the storage time).

The three different packaging bags were (1) Control Macro, (2) BOPP Micro, and (3) starch/polyethylene film. Bags dimensions: 18 cm*22 cm. Macro: BOPP material with 2 macro-perforation of 7 mm diameter (hand-made). Micro: BOPP material with 2 laser micro-perforations of 100 μm diameter (micro-perforation made with Perfotec equipment. BOPP film (rol) were purchased by Van der Windt. Bags were hand made with a seal bar instrument.

The gas composition within the packaging and the product quality were measured over time (Checkmate 2 from Dansensor, Ringsted, DK). Gas was analysed by sampling approximately 10 mL of headspace volume and analysed with Checkmate 2 instrument. Sampling was made with a needle through a rubber septum to avoid leakage during and after measurement.

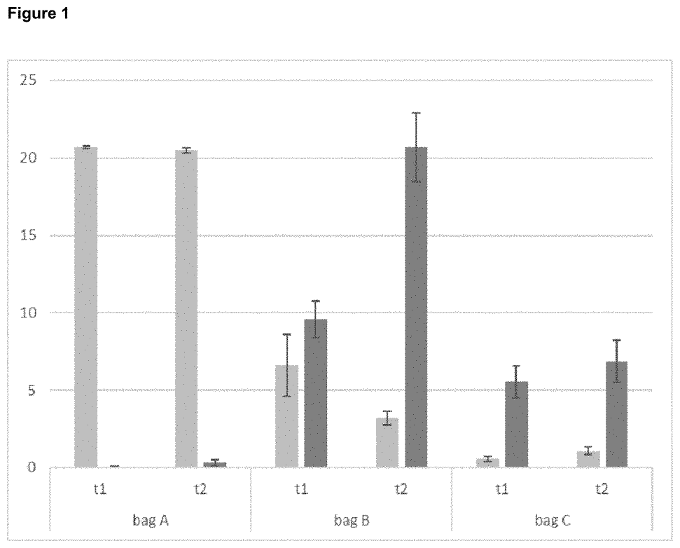

FIG. 1 depicts the gas composition in the headspace of different packages (bags) 5 days at 8° C., or after 5 days at 8° C.+5 days at 18° C.

Interestingly, the carbon dioxide concentration did not increase significantly in the starch/polyethylene—based packaging when the temperature increased from 8 to 18° C. The gas composition remains stable in the starch/polyethylene-based packaging, whereas in the BOPP packaging the carbon dioxide concentration more than doubled when the temperature increased by 10° C.

Table 3 shows that the firmness of the pears is better maintained in the starch-based bag (bag 3).

TABLE 3
Firmness (in kilogram) of pears packed in macro-perorated bag
(bag 1), in micro-perforated bag (bag 2) and in starch-based bag
(bag 3) on day 0, after 5 days at 8° C. and after 5 day at 8° C.
followed by 5 days at 18° C.

| | | | 5 days at 8° C. + |
|---|---|---|---|
| | day 0 | 5 days at 8° C. | 5 days at 18° C. |
| bag 1 | 5.1 ± 0.1 | 3.7 ± 0.2 | 1.01 ± 0.03 |
| bag 2 | 5.1 ± 0.1 | 4.5 ± 0.2 | 2.9 ± 0.2 |
| bag 3 | 5.1 ± 0.1 | 5.0 ± 0.2 | 4.1 ± 0.2 |

Application in Green Bananas

Nowadays green bananas are exported from South America to Europe in controlled atmosphere (CA) reefer containers or within MAP bags called Banavac. Banavac is a polyethylene bag with two micro-perforations. Using the respiration rate of the green banana, a modified atmosphere condition is created inside the bag. The low oxygen and high carbon dioxide levels inside the bag avoid the ripening process to occur during the shipping of the green banana. When green bananas are transported under CA conditions, the setting of the reefer container unit is fixed top 13.5° C., with 2-5% O₂ and 2-5% CO₂. The present starch based film can be used to pack green banana. When banana would be packed under more or less dry conditions, the oxygen and carbon dioxide content reach their optimal levels faster than within Banavac bag. After transport and prior ripening, an increasing of storage temperature (from 13,5 to 22° C.) will automatically raise up the relative humidity around the banana. This results in a higher permeability rate of the starch-based bag and so will allow higher exchange of oxygen and carbon dioxide between the bag headspace and the exterior. This allows the ripening process to start. It can be expected that no additional handling around the bag is needed between the end of the storage and the beginning of the ripening protocol. When green bananas are transported within banavac bag, an operator needs to open all the bags with a knife before starting the ripening process in order to allow the oxygen to enter the bag and remove the carbon dioxide. Using the starch based film, the cost for this extra handling can be reduced.

Permeability Tests

The oxygen and carbon dioxide transmission rates of the packaging materials were measured at two temperatures (22 and 8° C.) and two relative humidity (RH) levels (0% and 85%). For this, the packaging sheet was clamped between two pots: in the above pot, medical air (21% O₂ and 0% CO₂) was continuously flushed (100 mL/min); in the under pot, a gas mix of high level carbon dioxide and low oxygen content was flushed at the beginning of the test. In order to create stable relative humidity, the gas flushed in the top pot is first flushed through a bottle of dry silicate gel for the 0% relative humidity test or through a bottle of saturated potassium chloride solution for the measurement at 85% relative humidity. The gas content in the under pot was regularly measured using a Dansensor Checkmate 2 by sampling 10 mL of the air volume. The air pressure inside the under pot was also measured with pressure meter before and after each air sampling. The oxygen and carbon dioxide transmission rate of the sheet was then calculated by using a linear regression analysis of the oxygen and carbon dioxide (pure) volume over the time and corrected for a standard thickness of the foil sample of 100 μm. The oxygen and carbon dioxide content were first converted to volume of gas and corrected with the partial pressure difference measured before and after each gas measurement. The oxygen and carbon dioxide transmission rates are reported in the table below.

TABLE 4
Oxygen and carbon dioxed transmissions rates

| | Oxygen | | | Carbon dioxide | | | Selectivity | | |
|---|---|---|---|---|---|---|---|---|---|
| | (ml O₂/m².day.bar.100 μm) | | | (ml CO₂/m².day.bar.100 μm) | | | (CTR/OTR) | | |
| | 23° C.− | 23° C.− | 8° C.− | 23° C. | 23° C.− | 8° C.− | 23° C. | 23° C. | 8° C.− |
| | 0% | 85% | 85% | −0% | 85% | 85% | −0% | −85% | 85% |
| | RH | RH | RH | RH | RH | RH | RH | RH | RH |
| BOPP (without | 330 | 330 | 90 | 800 | 800 | 500 | 2.4 | 2.4 | 5.5 |
| perforation) | | | | | | | | | |
| starch/polyethylene | 330 | 1650 | 1600 | 850 | 8100 | 4800 | 2.6 | 4.9 | 3 |
| polymer-based film | | | | | | | | | |

Based on the measurements as shown, the hydrophilic/hydrophobic polymer-based sheet reacts to both storage conditions criteria: temperature and relative humidity, whereas the BOPP material reacts only, and in a lower rate, to the temperature criterium.

Based on these results, it can been concluded that:
1. the increase in concentration of carbon dioxide over time in the hydrophilic/hydrophobic polymer-based bags is much more limited than in the micro perforated BOPP bags. The final carbon dioxide content in the hydrophilic/hydrophobic polymer-based packaging was low enough to avoid any CO₂ damage in the pear fruit;
2. the amount of oxygen is lower in the hydrophilic/hydrophobic polymer-based bags than in the micro perforated BOPP bags;
3. the decrease in firmness in the pears packed in the hydrophilic/hydrophobic polymer-based sheet is comparable or lower than in the micro perforated BOPP sheet after the warm 5 day period. Therefore the quality seems better.
4. the colour of pears packed in the hydrophilic/hydrophobic polymer-based sheet remains similar to the initial colour or remain greener than pears packed in the micro-perforated BOPP sheet or packed in macro-perforated BOPP sheet after the storage period.

This shows that the present hydrophilic/hydrophobic polymer-based packaging material
1) is a material that shows dynamic change in carbon dioxide permeability resulting from temperature and RH variations. This leads to a better balanced atmosphere in the package particularly when ambient conditions as temperature and RH change. This significant change of permeability of the material makes the package particularly useful to maintain quality of fresh products in chains with varying or uncontrolled ambient conditions.
2) can be adjusted in the composition of the sheet so as to adjust the permeability of the packaging sheet, thus fitting a wide range of fresh products. The optimal permeability/packaging for each product: different fresh products require different permeabilities (to cope with different metabolism rates) and thermally responsive permeabilities to meet the requirements of changing ambient conditions throughout the distribution chain.

### EXAMPLE 2

Production of Starch/Polyethylene Film (2760 and 2761)

Manufacturing of the hydrophilic/hydrophobic film is performed in 2 steps:
3. production of a thermoplastic composition with a hydrophilic polymer phase, a hydrophobic polymer phase and a compatibilizer
4. production of a film out of the thermoplastic composition

ad 1-I: A powder/fluid mixture comprising:

2760 (100717-008)
29.9% native potato starch (type PN Avebe; 19% moisture content) (=hydrophilic polymer)
1.12% borax (type: Borax 10H2O GR Turkey obtainable from Brenntag)
1.12% fatty acid mixture (type Radiacid 0436, obtainable from Oleon)
0.56% glycerol mono stearate (type Radiasurf 7142 GMS, obtainable from Oleon)
0.22% sodium carbonate (type sodium carbonate anhydrous light Food (E500i) from Brenntag)
22.0% glycerol (type glycerine vegetable Pharm. (E422), obtainable from Brenntag)
41.1% LDPE (type Sabic LDPE 2008TN00) (=hydrophobic polymer)
4.0% compatibilizer (type Lotader 3410, obtainable from Arkema)

was compounded on a Berstorff ZE 40 A*38 D twin screw extruder equipped with a GALA LPU underwater pelletizer. Temperature profile along the barrel was: zone 1: 25° C.; zone 2: 60° C.; zone 3: 135° C.; zone 4: 160° C.; zone 5: 160° C.; zone 6: 160° C.; zone 7: 110° C.; zone 8: 95° C.; LPU: 120° C. Screw speed was 225 rpm. Total throughput was 26 kg/h. The compound was pelletized with help of the underwaterpelletizer (pellet size was about 4 mm) and dried to a moisture content of 3.4%.

ad 1-II: A powder/fluid mixture comprising:

2761 (100717-006)
38.97% native potato starch (type PN Avebe; 19% moisture content) (=hydrophilic polymer)
1.46% borax (type: Borax 10H2O GR Turkey obtainable from Brenntag)
1.46% fatty acid mixture (type Radiacid 0436, obtainable from Oleon)
0.73% glycerol mono stearate (type Radiasurf 7142 GMS, obtainable from Oleon)
0.29% sodium carbonate (type sodium carbonate anhydrous light Food (E500i) from Brenntag)
29.01% glycerol (type glycerine vegetable Pharm. (E422), obtainable from Brenntag)
22.83% LDPE (type Sabic LDPE 2008TN00) (=hydrophobic polymer)
5.26% compatibilizer (type Lotader 3410, obtainable from Arkema)

was compounded on a Berstorff ZE 40 A*38 D twin screw extruder equipped with a GALA LPU underwater pelletizer. Temperature profile along the barrel was: 30/90/150/160/160/160/110/95° C. in zones 1 till 8; Die temperature: 120° C. Screw speed was 225 rpm. Total throughput was 20 kg/h. The compound was pelletized with help of the underwaterpelletizer (pellet size was about 4 mm) and dried to a moisture content of 4.6%.

Ad 2: Starch/LDPE compound was processed into a symmetrical 3 layer film with help of a BFA/Battenfeld coextrusion multilayer (max=5) film blowing machine. Machine consisted out of a Battenfeld UNI-Ex 1-45-25B (central layer) and a BFA 30-25 extruder (for both coating layers) attached to a Battenfeld BK 50/150-05 multi spiral mandrel die. Central layer consisted out of the pelletized material as described under Ad 1. Both coating layers consisted out of a dry blend of 60% Sabic LDPE 2404, 30% Sabic LLDPE 6318 and 10% Lotader 3410. Layer distribution was: coating/central layer/coating=25/50/25. Processing temperatures were about 130° C. for the central layer and 145° C. for both coating layers. Total throughput was 9 kg/h. Film thickness was about 46 micron (2760) and 63 micron (2761). Stretch ratio in transverse direction is between 3 and 4. Stretch ratio in machine direction is between 8 and 9.

Material and Methods

a) Packaging Films

Further film materials according to the present disclosure (with the code 2760: referred as “starch film A” in the present document, and 2761: referred as “starch film B” in the present document) were tested with pears and mushrooms.

Both film were produced in 2017 by WFBR, their oxygen transmission rate, i.e. OTR properties were tested at 0 and 70% relative humidity and 23° C. The tables below show their OTR values.

| | | | OTR corrected at |
|---|---|---|---|
| | | OTR | 100 μm |
| | | [mlO₂/m² · day · bar] | [mlO₂/m² · day · bar] |
| Samples | Thickness | (23° C., 0% RH, | (23° C., 0% RH, |
| code | [μm] | 100% O₂) | 100% O₂) |
| Starch | 46.2 ± 2.0 | 826.3 ± 4.2 | 381.8 ± 18.3 |
| film A | | | |
| Starch | 63.2 ± 7.9 | 12.1 ± 1.0 | 7.60 ± 0.32 |
| film B | | | |

| | | | OTR corrected at |
|---|---|---|---|
| | | OTR | 100 μm |
| | | [mlO2/m² · day · bar] | [mlO2/m² · day · bar] |
| Samples | Thickness | (23° C., 70% RH, | (23° C., 70% RH, |
| code | [μm] | 100% O₂) | 100% O₂) |
| Starch | 46.2 ± 20 | 2996.6 ± 65.5 | 1385.1 ± 89.6 |
| film A | | | |
| Starch | 63.1 ± 7.9 | 1721.6 ± 205.2 | 1079.9 ± 6.6 |
| film B | | | |

The packaging treatments for the pears consisted of:
Reference packaging: Polypropylene film (Van der Windt, 30 mm thick) with 4 micro perforation of 100 μm diameter. The dimension of the bags was 18*27 cm (970 cm²)
Starch film A (code 2760): The dimension of the bags was 18*27 cm (970 cm²)
Starch film B (code 2761): The dimension of the bags was 18*27 cm (970 cm²)

The bags, with 4 pears per bag, were sealed under atmospheric gas conditions (20.8% O₂ and 0.1% CO₂).

Bag with product were first stored for 5 days at 5° C. and 100% relative humidity. Then they were transferred to storage room at 18° C. and 60% relative humidity.

Concerning the test with mushroom product, the following packaging treatments were used:
Reference packaging: Polypropylene film (Van der Windt, 30 mm thick) with 43 micro perforation of 100 μm diameter. The dimension of the bags was 18.5*27 cm (1000 cm²)
Starch film 1 (code 2760): The dimension of the bags was 18.5*27 cm (1000 cm²)
Starch film 2 (code 2761): The dimension of the bags was 18.5*27 cm (1000 cm²)

Bags were sealed with atmospheric gas condition (20.8% O₂ and 0.1% CO₂).

Bag with product were first stored for 5 days at 5° C. and 100% relative humidity. Then they were transferred to storage room at 18° C. and 60% relative humidity.

b) Products:

Pears can be considered as a fresh product with a relatively low respiration rate, mushroom is a fresh product presenting really high respiration activity.

Pear (conference) and mushroom were purchased at the local supermarket and stored at 5° C. for 24 hours.

Each bag consisted of 4 pears or one trays of mushroom (250g).

Results

a) Pear

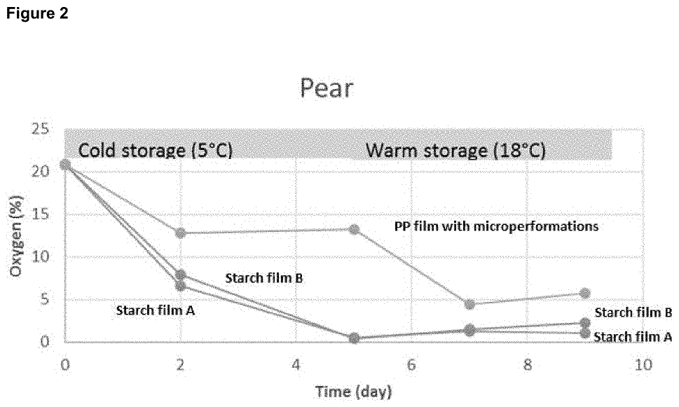

Oxygen and carbon dioxide concentrations were measured on day 0, 2, 5, 7 and 9 (FIG. 2).

Both treatments made of starch film followed similar gas patterns. Oxygen decreased during the period of storage at 5° C. to reach a level lower than 1%. When pears were transferred to the shelf life room, oxygen content into the packaging headspace increased slightly to a content of 2-3%. This can be explained by the dynamic property of the packaging material. Under higher storage temperature, the middle layer of the film structure was able to absorb more water from its direct surrounding (Water vapour transmission rate of the PE outside layer is directly temperature dependant). This engender a significant increase the total permeability property of the complete packaging made of starch material.

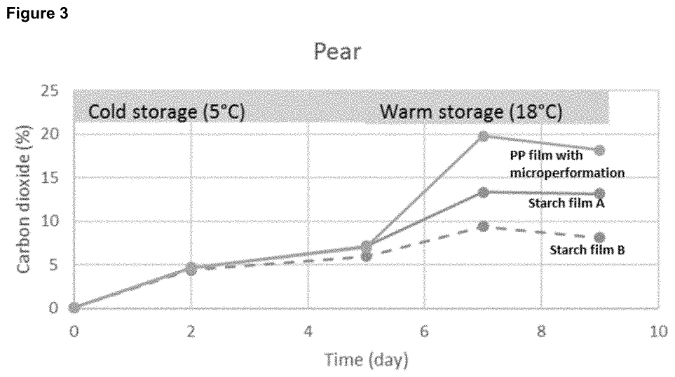

Concerning the carbon dioxide content into the packaging (FIG. 3), storage at 5° C. allowed to monitor the CO₂ content under 8% for all three packaging concepts. When transferring the bags to room temperature, the CO₂ content increased drastically to around 20% for the reference packaging. Using the starch film, the CO₂ content increased slightly but remained to an acceptable level after 4 days storage.

b) mushroom

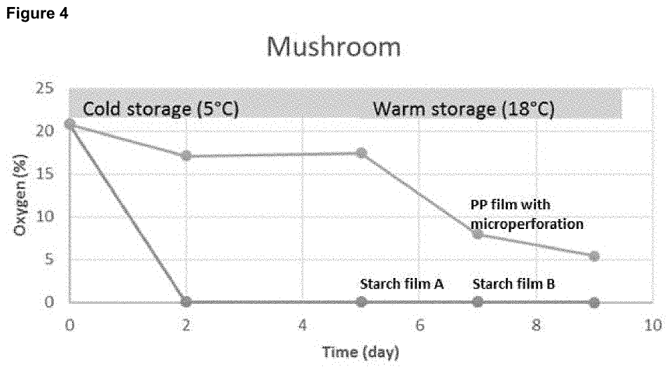

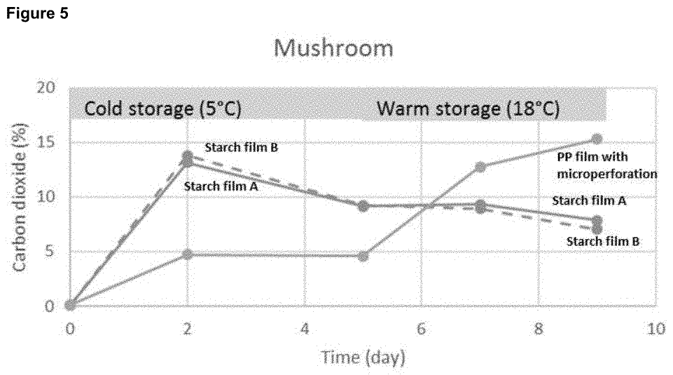

Oxygen and carbon dioxide concentrations were measured on day 0, 2, 5, 7 and 9 (FIGS. 4 and 5).

Both starch packaging followed similar gas content pattern. The oxygen inside the bag was completely consumed within two days storage at 5° C. The carbon dioxide content inside these bags increased first to 14% on day 2 and later on decreased and stabilised to 9%. The higher CO₂ content during the second days can be explained by the dynamic behaviour of the starch packaging. These packaging materials adjust their gas permeability to storage temperature and relative humidity. Higher is the relative humidity (inside and outside the bags), higher is the permeability to oxygen and carbon dioxide. At the beginning of the test, the starch material is still dry, and so is less permeable to CO₂ and O₂. This induced the peak of CO₂ content inside the bag observed on day 2. After few days under high relative humidity, the packaging material is getting more permeable to gas and resulted to a lower CO₂ content inside the bag headspace.

This phenomena is not observed for 02, as the oxygen was completely and directly consumed by the mushroom.

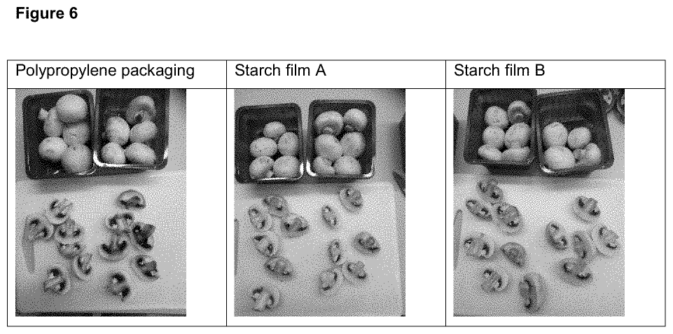

Concerning the quality of the mushroom at the end of the experiment (5 days at 5° C. followed by 4 days at 18° C.), packing inside the starch film allowed to keep the mushroom dry, firm and slow down the opening of the lamella under the mushroom head. At the contrary, packing into polypropylene bags with micro-perforations leaded to sliminess on the mushroom head, softening and brown discoloration of the complete mushroom tissue (FIG. 6).

On basis of these results, it can be seen that further improvement can be achieved by using a film that is somewhat less impermeable, since mushroom is a fresh product with an extremely high respiration rate activity. Accordingly, the thickness of the PE layer on both outer sides of the functional layer may be reduced, and/or the amount of starch composition in the functional middle layer may be increased. Using also thinner starch film material will also allow more gas exchanges.

To pack fresh products with a higher respiration rate such as mushroom, adjustments in the film material composition can be made. The following adjustments can make the film more permeable to oxygen and carbon dioxide:
reducing the thickness of the PE outside layer(s);
increasing the Starch/PE ratio in the functional middle layer;
adjusting the starch structure (mono- or multi-branches structure) may also help to increase the permeability of the film.

1. A method for extending shelf-life of at least one biological product comprising:
providing a sheet for packaging the at least one biological product; and
dynamically modifying an atmosphere surrounding the at least one biological product in response to one or more of 1) the biological activity of the at least one biological product, 2) the storage temperature, and 3) the relative humidity in the direct surrounding of the at least one packaged biological product, thereby extending shelf-life of the at least one biological product, wherein the sheet comprises or consists of a thermoplastic composition with:
a hydrophobic polymer phase having a water absorption capacity of at most 5 ml water per 100 g of the at least one hydrophobic polymer phase;
a hydrophilic polymer phase having a water absorption capacity of at least 5 ml water per 100 g of the at least one hydrophilic polymer phase; and
optionally at least one compatibiliser.

2. The method according to claim 1, further comprising maintaining a controlled atmosphere surrounding the at least one biological product, wherein the concentration of CO₂ is kept between 0 and 10 vol. % and/or the concentration of O₂ is kept between 0 and 10 vol. %.

3. The method according to claim 1, wherein the biological product contains at least 1, 5, 10, 20 or 40 wt. % living biological cells and/or is chosen from the group consisting of fruit, vegetable, and/or flower.

4. The method according to claim 1, wherein the at least one hydrophobic polymer phase has a water absorption capacity of at most 4, 3, 2, 1, 0.5, 0.4, 0.3, 0.2, or 0.1 ml water per 100 g of the at least one hydrophobic polymer phase and/or wherein the at least one hydrophobic polymer is chosen from the group consisting of fossil-based polymer, biopolymer, polyester, polyolefin, preferably polyethylene.

5. The method according to claim 1, wherein the at least one hydrophilic polymer phase has a water absorption capacity of at least 10, 20, 30, 40, or 50 ml water per 100 g of the at least one hydrophilic polymer and/or wherein the at least one hydrophilic polymer is a carbohydrate or a protein, preferably chosen from the group consisting of wheat gluten, chitosan, pullulan, pectin, myofibrillar protein, and starch, preferably thermoplastic starch.

6. The method according to claim 1, further comprising at least partially covering the at least one biological product with the sheet during a period having a temperature variation of at least 4° C. and/or a relative humidity variation of at least 4%, wherein preferably the temperature variation during the period is at least 5, 6, 7, 8, 9, 10, 11, 12, 13, 14, 15, 20 or 25° C. and/or wherein the relative humidity variation during the period is at least 5, 6, 7, 8, 9, 10, 11, 12, 13, 14, 15, 20, 25, 30, 35, 40, 45, or 50%.

7. The method according to claim 1, wherein the period during which the at least one biological product is packaged is at least 4, 6, 8, 10, 12, or 14 days and/or wherein the method is during transport.

8. The method according to claim 1, wherein the sheet at least partially defines an outer surface of a controlled atmosphere that at least partially surrounds the at least one biological product, preferably wherein the sheet defines between 1-100%, 1-80%, 1-60%, 1-40%, 1-20%, 20-100%, 40-100%, 60-100%, or 80-100% of said outer surface.

9. The method according to claim 1, wherein the sheet contains between 1-50, 1-25, 1-10, 40-80, or 50-90 wt. % of the hydrophilic polymer; and/or wherein the thickness of the sheet is between 1-50 μm, 5-40 μm, 5-30 μm, 40-70 μm, 50-100 μm, or 70-100 μm.

10. The method according to claim 1, wherein the sheet is an in at least one direction stretched sheet obtained by blowing, casting or stretching the thermoplastic composition in a machine direction and a transverse direction at elevated temperature and/or wherein the sheet has a layered morphology preferably with an internal layer comprising of the thermoplastic composition and/or one or two outer layer(s) comprising of thermoplastic composition, preferably hydrophobic polymer phase having a water absorption capacity of at most 5 ml water per 100 g of the at least one hydrophobic polymer phase, wherein preferably the at least one hydrophobic polymer is chosen from the group consisting of fossil-based polymer, biopolymer, polyester, polyolefin, and preferably polyethylene.

11. The method according to claim 1 wherein the thermoplastic
composition comprises
between 10-80 wt. % of the at least one hydrophobic polymer;
between 10-80 wt. % of the hydrophilic polymer; and/or
between 1-40 wt. % of the at least one compatibiliser.

12. The method according to claim 1, wherein the compatibiliser is a block or graft copolymer, nonreactive polymer containing polar groups or reactive functional polymer, preferably chosen from the group consisting of ethylene vinyl acetate copolymers, partially hydrolysed and saponified polyvinylacetate, polyolefins having at least 1 wt. % maleic anhydride grafted thereon, ethylene vinyl alcohol copolymers, ethylene acrylic acid copolymers, random terpolymers of ethylene, butylacrylate and maleic anhydride or mixtures thereof.

13. The method according to claim 1, wherein the thermoplastic composition further comprises a thermoplastic polyester, preferably poly(butylene terephthalate-co-adipate) in an amount of between 20-60 wt. %.

14. The method according to claim 1, further comprising extending and/or postponing a ripening process of the at least one biological product.
